(19) United States
(12) Patent Application Publication
(10) Pub. No.: US 2007/0000347 A1
(43) Pub. Date: Jan. 4, 2007

(54) Kickdown mechanism for pedal assembly

(76) Inventors: Mark Keown, Christchurch (NZ); John Herrick, Aloha, OR (US); Jim Honyak, Salem, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/174,008

(22) Filed: Jun. 30, 2005

(51) Int. Cl. G05G 1/14

(52) U.S. Cl. 74/560

(57) ABSTRACT

A pedal assembly is disclosed having a movable slide adapted to contact a kickdown feature and further adapted to overcome the kickdown feature upon application of additional force to result in a kickdown effect that may correspond to an engine kickdown. The movable slide may be adapted for frictional engagement with a body to impart a hysteresis effect as the slide moves relative to the body.

### TECHNICAL FIELD

Embodiments of the present invention relate generally to the field of vehicle pedals, and more particularly to a throttle pedal assembly having a hysteresis and a kickdown feature.

### BACKGROUND

Non-mechanical control of vehicles is becoming increasingly more common. Such systems generally include an electronic opening and closing of the engine throttle based on position of a throttle pedal that may be operated by an operator or driver. These systems are typically without, however, a mechanical connection such as a cable between the engine and the throttle pedal. Consequently, a driver or operator may lose a tactile feel or feedback from the engine. One aspect of the loss of tactile feel is what is known as the hysteresis, which may be the effect of pedal resistance the operator feels as the pedal is depressed. Another aspect is the point at which the engine kicks down to a lower gear, such as when the vehicle is going up a hill or attempting to pass.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIGS. 1a, 1b and 1c illustrate sectional views of a first described embodiment of the present invention;

FIG. 2 illustrates a cross-sectional view of a second embodiment of the invention;

FIGS. 3a, 3b, 3c and 3d illustrate cross-sectional views of a third described embodiment of the present invention;

FIG. 4 illustrates a cross-sectional view of a fourth described embodiment of the invention;

FIG. 5 illustrates a side view according to a fifth described embodiment of the invention;

FIG. 6 illustrates a sectional view according to a sixth described embodiment of the invention;

FIGS. 7 and 7a illustrate a side view and a detailed side view, respectively, of a seventh described embodiment of the invention;

FIG. 8 illustrates a flow diagram illustrating a method in accordance with an embodiment of the invention;

FIG. 9 illustrates a flow diagram illustrating a method in accordance with another embodiment of the invention;

FIG. 10 illustrates a flow diagram illustrating a method in accordance with another embodiment of the invention;

FIG. 11 illustrates a flow diagram illustrating a method in accordance with another embodiment of the invention; and

FIGS. 12a, 12b and 12c illustrate sectional views of a first described embodiment of the present invention.

### DETAILED DESCRIPTION OF ILLUSTRATIVE EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made in alternate embodiments. Therefore, the following detailed description is not to be taken in a limiting sense, and the scope of embodiments in accordance with the present invention is defined by the appended claims and their equivalents.

The following description may include terms such as inner, outer, under, between, upward, downward, outward, inward, top, bottom, above, below and the like. Such terms are used for descriptive purposes only and are not to be construed as limiting in the description or in the appended claims. That is, these terms are terms that are relative only to a point of reference and are not meant to be interpreted as limitations but are, instead, included in the following description to facilitate understanding of the various aspects of the invention.

Embodiments of the present invention may be directed to electrically and electronically controlled pedal assemblies having a kickdown feature coupled to the pedal assembly housing that is adapted to provide a resistance at a set pedal position to signal the pedal range at where engine/transmission kickdown is likely to occur. In one embodiment, a throttle pedal may include a kickdown feature wherein a determined resistance may be overcome to then allow the pedal to be further depressed, wherein the determined resistance point coincides with engine/transmission kickdown. In some embodiments, the pedal assembly may also include a hysteresis component aimed at providing additional variable resistance to the pedal as it is applied and released combined with a kickdown feature in a simple and efficient design. Further embodiments of the present invention may include a kickdown feature that may be modified, changed, and/or manipulated to increase or decrease both the kickdown position and the amount of kickdown resistance.

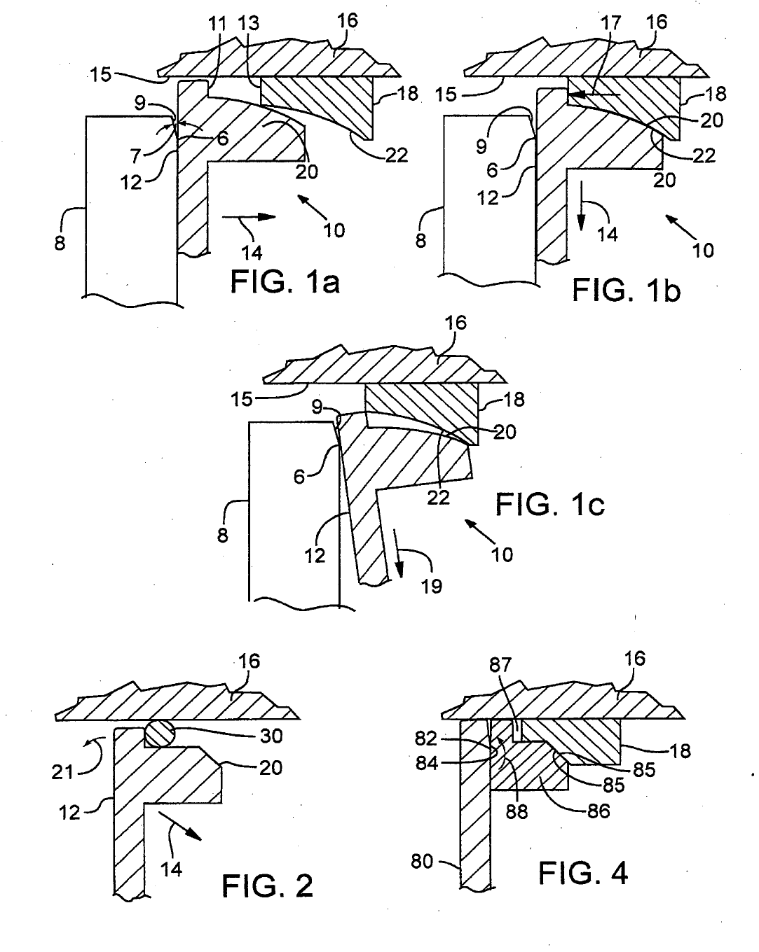

FIGS. 1a, 1b and 1c Illustrate cross sectional views of an embodiment of the present invention wherein a pedal arrangement 10 includes a slide 12 movable by actuation of a pedal member 8 generally in a direction 14. Pedal 8 may have an upper relieved portion 9 that may make an angle-7 with respect to slide 12. The interface between relieved portion 9 and slide member 12 may create a tipping point 6 about which slide 12 may tip.

A kickdown feature 18, which may be in the form, for example, of at least one of a variety of bumps, protrusions or other objects, may be positioned in the path of the slide 12 and carried by body 16. The slide 12 may have a slide contact surface 11 adapted to contact a kickdown surface 13, such that a force 17 is generated to oppose the force being applied on slide 12 by pedal 8.

FIG. 1b illustrates the slide 12 having made contact with the kickdown feature 18. As the slide contact surface 11 contacts kickdown surface 13, opposing force 17 may cause slide 12 to tip at tipping point 6. FIG. 1c illustrates the slide 12 in a tipped position. As the slide tips about tipping point 6, the interface between the second slide friction surface 20 and kickdown friction surface 22, may help cause the slide 12 to move past the kickdown surface 13 in generally a direction 19 in a “crowbar”-type manner such that slide 12 may slip past kickdown surface 13 of kickdown feature 18. The effect felt by the operator may be one of a sudden release of an opposing force against the actuation of the pedal 8. This “kickdown” point may be the point where the engine/transmission kickdown can occur, and the overcoming of the increase in resistance may provide the tactile feedback to the operator signaling engine kickdown.

In one embodiment, as the slide 12 moves in direction 14 the second slide contact surface 20 may frictionally engage a second kickdown surface 22 in one embodiment, the friction component between the second slide contact surface 20 and the second kickdown surface 22 may provide a hysteresis effect against the movement of the pedal. It can be appreciated, however, that there need be no frictional contact between the second slide contact surface 20 and the second kickdown surface 22, or even need be any contact (as further shown, for example, in FIG. 2). Further, in other embodiments, an upper portion of the slide may be adapted to frictionally engage the body 16 as the slide is moved towards the kickdown feature 18, such that a hysteresis effect is felt as the pedal is actuated up to the point where the slide contact surface contacts the kickdown surface.

In one embodiment of the present invention, a spring or other biasing member, may be coupled to or a part of the kickdown contact surface to provide measured resistance and a more gradual opposing force to the pedal movement. In one embodiment, the angle 7 of the relieved portion may be increased or decreased as desired to increase or decrease the kickdown effect. While the pedal member 8 is generally shown to move slide 12 in a generally linear direction, it can be appreciated that in other embodiments, the slide may be moved in an arcuate path, and the kickdown feature may be correspondingly positioned in such arcuate path.

FIG. 2 illustrates a cross sectional view of another embodiment of the invention wherein a slide 12 is urged into contact with a kickdown feature 30. The kickdown feature 30 exerts a resistance force on the slide causing the slide to tip in direction 21. Once tipped, slide 12 may slip past kickdown feature 30 as the force on the slide overcomes the resistance force generated by the kickdown feature. Other embodiments may include kickdown features and/or slides of different shapes and proportions in order to adjust the kickdown effect.

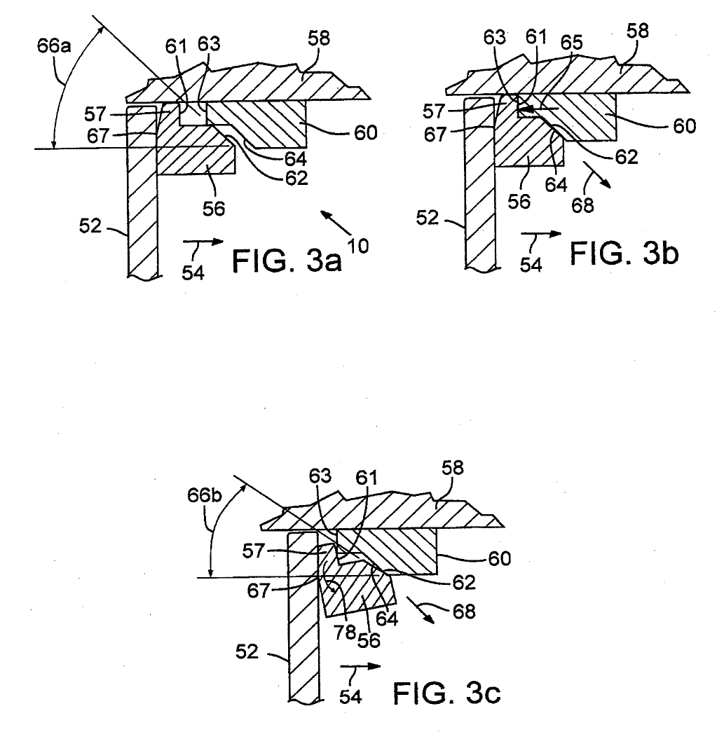

FIGS. 3a, 3b, 3c and 3d illustrate cross sectional views of an embodiment of the present invention wherein a pedal arrangement 50 includes a pedal actuatable member 52 movable generally in direction 54. A slide 56 may be in sliding contact with and may at least move in direction 54 with the pedal actuatable member 52. In one embodiment, as the pedal actuatable member 52 moves in direction 54 the slide 56 may slide against a body 58. A friction force between the body 58 and the slide 56 may provide a hysteresis effect by providing variable resistance against the movement of the pedal actuatable member 52.

A kickdown feature 60 may be in the path of the slide 56, such that a slide contact surface 61 may be adapted to contact kickdown surface 63, and wherein a second slide contact surface 62 may be adapted to contact a second kickdown surface 64 as the slide 56 approaches the kickdown feature 60. The second slide contact surface 62 may be adapted to contact second kickdown surface 64 at an approach angle 66a, which may add to the resistance force 65 opposing the force applied by the pedal member 52.

FIG. 3b illustrates the slide 56 having made contact with the kickdown feature 60. As the slide continues to move in direction 54 the slide contact surface 62 slides along second kickdown surface 64 generating an increased friction force, which may thereby add to the hysteresis effect. A relieved upper portion 57 of slide 56 may begin to tip at inflection point 67 in direction 78, and the slide 56 may move away from the body 58 in at least direction 68.

FIG. 3c illustrates the slide 56 fully tilted in direction 78 and a changed approach angle 66b. The changed approach angle 66b can help urge the slide 56 to move in direction 68 and pass kickdown feature 60, as the amount of opposing force applied on slide 56 by kickdown feature 60 may be reduced. As the slide 56 passes kickdown feature 60, the kickdown effect will be felt by the user.

In one embodiment, the amount of relief may be increased or decreased depending on the amount of tilt that may be required to attain the necessary kickdown feel. Also, the attach angle of the second contact surfaces may be varied or eliminated to further modify the kickdown effect. In other embodiments, the relief may be on a forward portion of the slide, or may be a part of the kickdown feature itself.

FIG. 4 illustrates a cross-sectional view of an embodiment, of the present invention. A pedal actuatable member 80 includes an inflection point 82 defining a tilt point 84 about which slide 86 may tilt as represented by arrow 88. The configuration of the kickdown feature is such that the second contact surfaces 85 contact before the primary contact surfaces 87 contact. The reaction of the slide will be similar to that as described in previous embodiments, however, the slide will be urged downward along pedal member 80 before the primary contact surfaces 87 contact each other to generate the a tilting on inflection point 86. A tilt or inflection point, according to embodiments of the invention, may include but is not limited to: inflection points wherein nonparallel planar surfaces meet; wherein a curved surface such as convex surface abuts a planar surface; and/or wherein curved surfaces abut. The slide may also be configured in any appropriate way, or elements may be added or subtracted to provide tiltability.

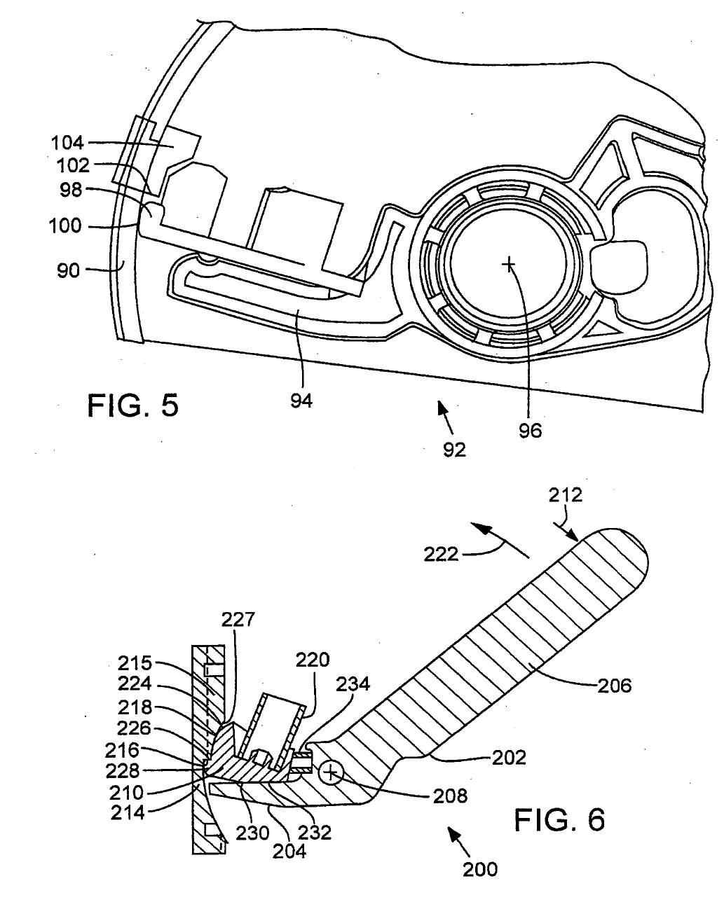

FIG. 5. illustrates a side view according to an embodiment of the present invention. An arcuate body portion 90 may be positioned proximal to a pedal arrangement 92 including a pedal actuatable member 94 being pivotal about a center point 96. A slide 98 may be adapted to move with the pedal actuatable member 94 about the center point 96 being actuated by a pedal (not shown). The slide 98 may include frictional engagement between frictional hysteresis contact surface 100 and body 90 to provide for a hysteresis effect.

The slide 98 may be adapted to contact kickdown surface 102, which may be adjustably coupled to the body 90. During pedal rotation about point 96, the slide 98 comes in contact with the kickdown surface 102 of kickdown feature 104, such that pedal movement is impeded. Upon application of a kickdown force the slide will slide over the kickdown feature allowing the pedal to continue to move.

FIG. 6 illustrates a sectional view according to a sixth described embodiment of the invention. A throttle pedal 200 comprises a pedal actuatable member 202 having a first end 204 and a second end 206 being pivotable about an axis 208, the axis 208 being between the first end 204 and the second end 206. A slide 210 may be in sliding engagement with the first end 204 and is movable with the first end upon a force 212 being applied to the second end 206. The first end 204 may be adapted to move proximal to a contact surface of body 214. The slide 210 may be disposed such that it is in frictional engagement with a body 214 such that movement of the first end 204 about axis 208 may result in a hysteresis effect in response to depressing and releasing of pedal 206.

In one embodiment, a kickdown feature 215 may be disposed within and integral with the body 214, and thus stationary relative to the axis 208. The slide 210 may have a primary slide contact surface 216 and a secondary slide contact surface 218 adapted to engage the primary and secondary kickdown feature contact surfaces 226 and 227.

The pedal actuatable member 202 may be impeded from movement by a resistance force generated when primary slide contact surface 216 contacts primarily kickdown feature contact surface 226. As force is applied to the pedal, the slide 210 may begin to tip at inflection point 230. Slide 210 may also slide along the first end 204 toward the axis 208. With the application of sufficient force in combination with the tilting of the slide disruption the complementary fit of the primary contact surfaces a sufficient tilting effect, the slide 210 may be rapidly urged past the primary kickdown feature contact surface 216, thereby relieving the resistance force and resulting in the kickdown effect.

The throttle pedal assembly 200 may further have a biasing member 220 which may include, but is not limited to, a coil spring, a leaf spring, a compression spring, a tension spring, elastomers, or any other known biasing material. The biasing member 220 may be arranged to bias the pedal actuatable member 202 to a throttle closed direction 222. The biasing member 220 may contact the slide 210 and hold the slide 210 against the first end 204. The biasing member 220 may then in turn act on the pedal actuatable member 202 to return the throttle pedal to an idle position after the resistance force is relieved. The slide 210 may be a rigid element or a resilient element that compresses while being pressed against the kickdown feature 216.

The biasing member 220 may have a force component biasing the slide 210 toward the body 214. For example, the biasing member 220 may be positioned at an angle toward the body. As the pedal actuatable member 202 moves against the biasing member 220 the amount of force the biasing member 220 exerts on the slide 210 increases with increased displacement, which in turn increases the resistance encountered due to the increased rotational resistance of the slide 210 at inflection point 230. Thus the resistance generally increases with depression of the pedal, resulting in an increased resistance felt by the operator.

In one embodiment, the kickdown feature 215 may include kickdown surface 224 shaped substantially similar to the shape of the slide contact surface 218 such that they have a complementary fit and the slide contact surface 218 is adapted to contact the kickdown surface 227. The surfaces may, for example, be concentric curves or parallel planes or may be combinations of various geometric relationships.

A second biasing member 234 may be provided to urge the slide 210 toward the body 214, which may help to urge the slide 210 back to frictional engagement with the body 214 after the kickdown effect is no longer in place; that is, the pedal 200 is released and pivoted back to an idle position. Altering the force of second biasing member 234 can be used to further alter the hysteresis effect and /or the kickdown force of the pedal assembly.

The pedal arrangement may be configured to have replaceable or interchangeable parts, for example, interchangeable kickdown features and slides while using common other parts of the arrangement. This may reduce manufacturing and assembly costs as slides and corresponding kickdown features with different angular relationships between the slide contact surface and the kickdown surface can be used to adjust the kickdown effect from a stiff effect to a resilient effect. Further, other kickdown feature geometric configurations may be employed to vary the kickdown effect and position at where kickdown occurs.

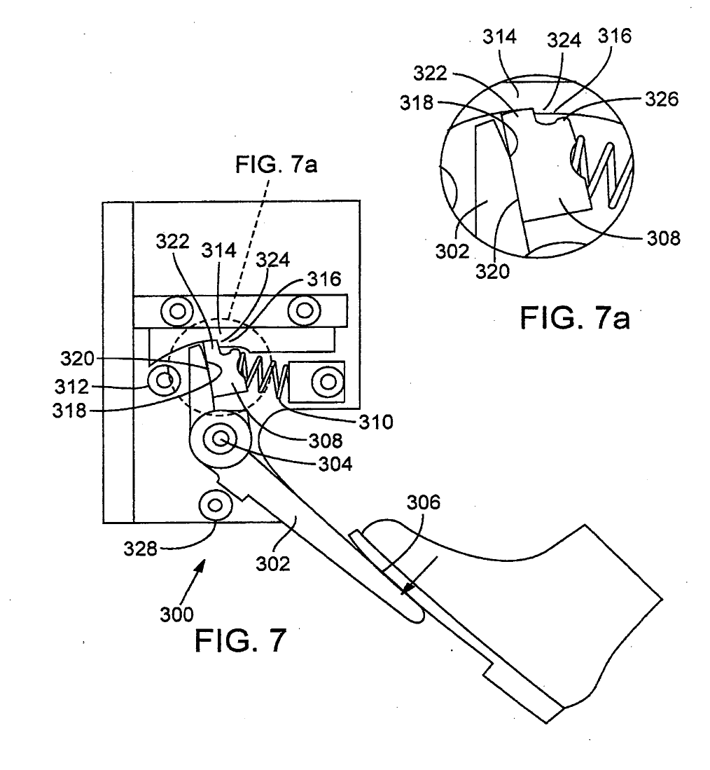

FIGS. 7 and 7a illustrate a side view and a detailed side view, respectively, of an embodiment of the present invention. A pedal arrangement 300 includes a pedal actuatable member 302 pivot-ably arranged at a rotation point 304 with a pedal pad 306 on one end thereof. A slide 308 may be held against the pedal actuatable member 302 with a biasing member such as a return spring 310. The return spring 310 may also act to bias the pedal actuatable member 302 toward a throttle closed stop 312. Upon applying a force to the pedal pad 306 the slide 308 may be urged up towards body 314, by return spring acting in a resistive and angular relationship to the slide 308. As the pedal is further depressed, the magnitude of the urging increases, thus resulting in an increased hysteresis effect.

The body 314 may include a kickdown feature 316, which can be integral with, or a component coupled to the body 314. The slide 308 may contact the kickdown feature 316. Upon making contact, a resistance to further movement may be felt at the pedal pad 306 until a kickdown force is exerted to force the slide 308 to move past the kickdown feature 316. A tilt point 318 is defined at a junction 320 between the slide 308 and the pedal actuatable member 302 about which the slide 308 may tip. The slide 308 has a tilt arm 322 contactable by a protrusion 324 on the kickdown feature 316 that may tip the slide 308 slightly. The slide 308 also has a nose 326. When tipped the nose 326 may make contact with the kickdown feature 316 providing a further and rapid tilt of the slide 308 in a “tilt and trip” motion. A very rapid reduction of the resistance force may be felt at the pedal pad 306 when the slide is tripped. A throttle open stop 328 limits the movement of the pedal actuatable member 302.

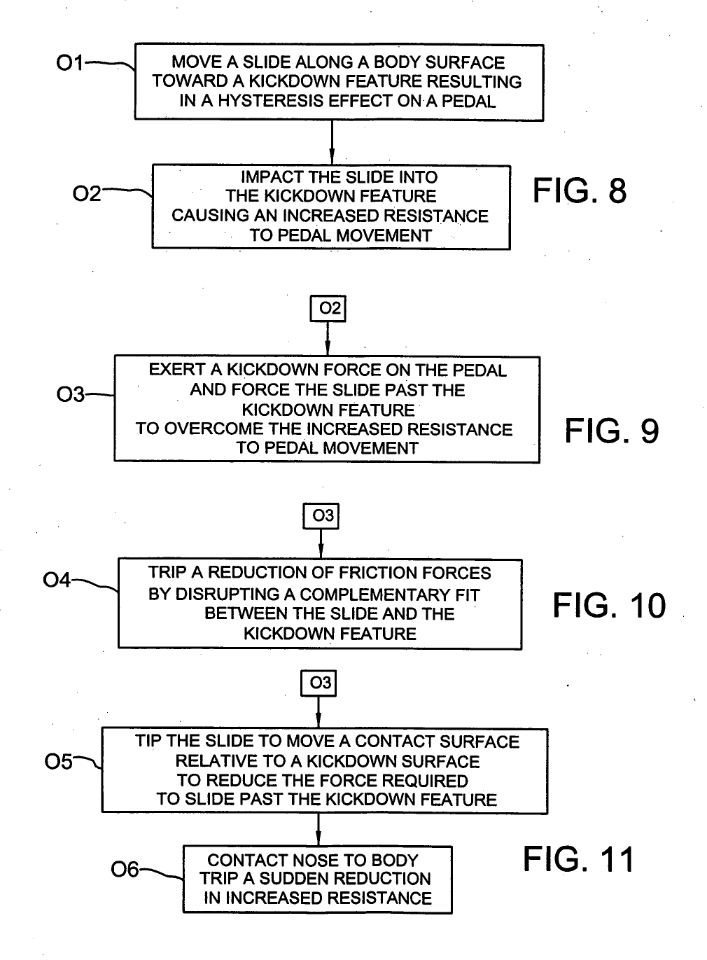

FIG. 8 illustrates a flow diagram illustrating a method in accordance with an embodiment of the invention. The method includes:
O1, moving a slide along a body surface towards a kickdown feature, which may result in a hysteresis effect from depression and release of a pedal;
O2, impacting the slide into the kickdown feature causing an increased resistance to pedal movement.

The moving of the slide may be in a rectilinear or in an arcuate or circumferential direction, and forcing the slide past the kickdown feature may include moving the slide in a radial direction, or direction nearly perpendicular, or otherwise to the initial movement direction of the slide.

FIG. 9 illustrates a flow diagram illustrating a method in accordance with an embodiment of the invention. According to another embodiment the method may further include:
O3, exerting a kickdown force on the pedal and forcing the slide past the kickdown feature and overcoming the increased resistance to pedal movement.

FIG. 10 illustrates a flow diagram illustrating a method in accordance with an embodiment of the invention. According to another embodiment, the method may further include:
O4, forcing the slide by tripping a reduction of friction forces between the slide and the kickdown feature by disrupting a complementary fit between the slide and the kickdown feature.

FIG. 11 illustrates a flow diagram illustrating a method in accordance with an embodiment of the invention. According to another embodiment the method may further include:
O5, tipping the slide so that a contact surface on the slide moves relative to a friction surface on the kickdown feature reducing a force required to force the slide past the kickdown feature. Which may include:
O6, contacting a nose to the body and tripping a sudden reduction in resistance.

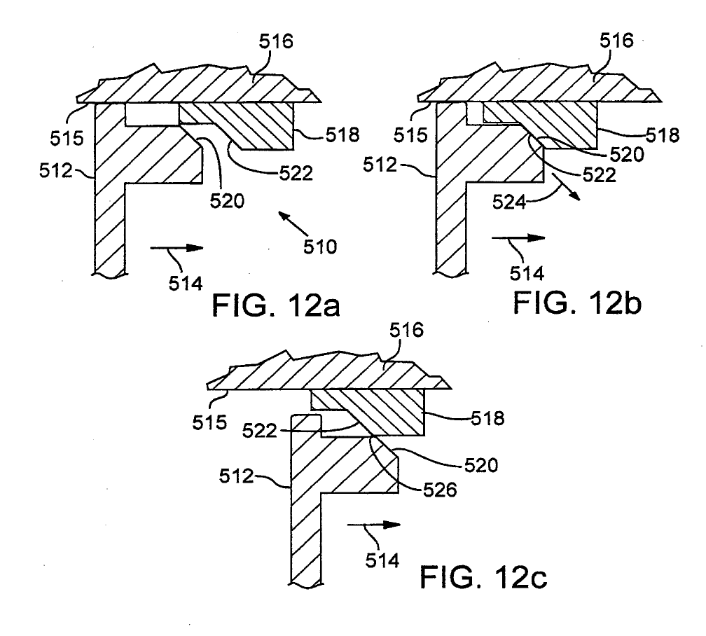

FIGS. 12a-12c illustrate sectional views of a an embodiment of the present invention, wherein a pedal arrangement 510 includes a slide 512 movable generally in a direction 514, which may be actuated by a movement of a pedal (not shown). As the slide 512 moves in direction 514 it may be in frictional contact with a contact surface 515 of body 516. Such contact surface may be the body 516, or may be a variety of materials, which line body 516. A friction component between the body 516 and the slide 512 may provide a hysteresis effect against the movement of the pedal.

A kickdown feature 518, which may be in the form, for example, of at least one of a variety of bumps, protrusions or other objects, may be positioned in the path of the slide 512 and carried by body 516. The slide 512 may be adapted for contact with the kickdown feature 518 wherein a slide contact surface 520 may contact a corresponding kickdown surface 522.

FIG. 12b illustrates the slide 512 having made contact with the kickdown feature 518. As the slide continues to move in direction 514 the slide contact surface 520 may slide along kickdown surface 522. As the slide continues to move in direction 514, the slide 512 may be urged away from the body 516 generally in direction 524.

FIG. 12c illustrates the slide contact surface 512 moving past an end 526 of the kickdown surface 522 whereupon it breaks contact with the kickdown surface 522 and is then movable in direction 514 unencumbered by the resistance force of the kickdown surface 522 acting on the slide contact surface 520. The effect felt by the operator may be one of: a hysteresis force/effect while the slide 512 rubs on the body 516. When the contact surface 520 contacts the kickdown surface 522 an increased resistance may be temporarily encountered while the slide contact surface 520 slides along the kickdown surface 522. Then a relatively sudden drop in the pressing force required may be felt as the slide contact surface 520 disengages from the kickdown surface 522. This may be the point where the engine/transmission kickdown can occur, and the overcoming of the increase in resistance may provide the tactile feedback to the operator signaling engine kickdown.

Embodiments of the present invention may be used with any type of pedal assembly, including, but not limited to suspended pedals, floor mounted pedals, remote pedal assemblies and the like. Embodiments of the present invention may be configured to have a hysteresis effect in conjunction with, or separate from, a kickdown feature. Embodiments may also be used with a pedal having a contact surface which is part of a housing or which is separate from a housing. Embodiments may also be configured with an arcuate housing or a straight housing. Embodiments may also be configured wherein the kickdown feature is configured with the housing, or configured separate from the housing. Embodiments may include a slide made from a substantially non-deformable material. Embodiments may include a slide made from an acetyl resin. Embodiments may include a body or a contact surface on the body made from a glass-filled nylon.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A pedal assembly comprising:
a body;
a kickdown feature carried by the body;
a pedal actuatable member; and
a movable slide coupled to the pedal actuatable member and adapted to move relative to the body and contact the kickdown feature, wherein such contact temporarily impedes the movement of the slide, and wherein the slide and the kickdown feature further are adapted to allow the slide to pass the kickdown feature by moving in a second direction relative to the body thereby resulting in a kickdown effect.

2. The pedal assembly of claim 1, wherein the pedal actuatable member imparts a first force on the slide causing the slide to move in a first direction relative to the body, the kickdown feature adapted to apply a second force having a component opposite the first force to temporarily impede movement of the slide in the first direction, and wherein the kickdown effect is caused when the first force overcomes the second force.

3. The pedal assembly of claim 1, wherein the slide is adapted to tilt relative to the pedal actuatable member about a tilt point in order to help disrupt an engagement between the slide and the kickdown feature and urge movement of the slide in the second direction.

4. The pedal assembly of claim 3, wherein the slide has a tilt arm defined by a relieved portion of the slide, and wherein contacting the tilt arm with the kickdown feature results in a tilt of the slide about the tilt point.

5. The pedal assembly of claim 3, wherein the pedal actuatable member has a relieved portion, the interface between the relieved portion and the slide defining the tilt point, and wherein contacting the movable slide with the kickdown feature results in a tilt of the slide about the tilt point.

6. The pedal assembly of claim 3, wherein the slide and the kickdown feature contact at a second contact surface, and wherein contact at the second contact surface helps cause the slide to pass the kickdown feature to cause the kickdown effect.

7. The pedal assembly of claim 1, wherein the body has a first contact surface, and the slide is adapted to frictionally engage the first contact surface of the body to create a hysteresis effect as the pedal actuatable member moves the slide in a first direction.

8. The pedal assembly of claim 1, wherein the slide is in sliding engagement with the pedal actuatable member.

9. The pedal assembly of claim 7, further comprising a biasing member arranged to help hold the slide against the pedal actuatable member and arranged to bias the pedal actuatable member toward a throttle closed position.

10. The pedal arrangement of claim 9, wherein the biasing member generates a biasing force directed in part toward the first contact surface that increases the frictional engagement between the movable slide and the first contact surface of the body upon continued actuation of the pedal actuatable member.

11. The pedal assembly of claim 1, wherein the pedal actuatable member is configured to traverse on an arcuate path.

12. A throttle pedal assembly comprising:
a pedal actuatable member having a first end and a second end being pivot-able about an axis;
a slide adapted to move with the first end upon a first force being applied to the second end;
a kickdown feature being fixed relative to the axis; and
the slide adapted to contact the kickdown feature, to impede movement of the pedal actuatable member by a resistance force, the slide adapted to move relative to the kickdown feature and adapted to move relative to the first end of the pedal actuatable member when sufficient force is applied to the second end to overcome the resistance force and to allow the slide to move past the kickdown feature.

13. The throttle pedal of claim 12, further comprising:
a body, the slide being adapted to frictionally engage the body to impart a hysteresis effect to the movement of the pedal actuatable member.

14. The throttle pedal of claim 13, further comprising a biasing member, the biasing member arranged to bias the pedal actuatable member to a throttle closed direction, the biasing member in contact with the slide and configured to help hold the slide against the pedal actuatable member and urge the slide against the body.

15. The throttle pedal of claim 14, further comprising a second biasing member disposed to resist movement of the slide relative to the pedal actuatable member.

16. The throttle pedal of claim 13, wherein the slide is contactable with the kickdown feature at a second contact surface, and the kickdown feature includes a kickdown surface being substantially parallel with the second contact surface.

17. The throttle pedal of claim 16, wherein the slide is adapted to approach the kickdown feature from an approach direction, and the second contact surface and the kickdown surface forming an approach angle with the approach direction, the approach angle being adjustable to adjust a resilient feel to the throttle pedal.

18. The throttle pedal of claim 12, wherein the slide is adapted to tilt relative to the pedal actuatable member about a tilt point.

19. The throttle pedal of claim 18, wherein the slide further comprises:
a slide first contact surface adapted to contact a first kickdown surface; and
a slide second contact surface adapted to contact a second kickdown surface
wherein contact between the slide first contact surface and the first kickdown surface urges the slide to tilt about the tilt point and contact between the slide second contact surface and the second kickdown surface helps urge the slide past the first kickdown surface.
